(19) United States
(12) Patent Application Publication
(10) Pub. No.: US 2018/0098182 A1
(43) Pub. Date: Apr. 5, 2018

(54) SYSTEMS, METHODS, AND DEVICES FOR DUAL-MODE COMMUNICATION IN A PERSONAL AREA NETWORK

(71) Applicant: INTEL CORPORATION, SANTA CLARA, CA (US)

(72) Inventors: JAROSLAW J. SYDIR, SAN JOSE, CA (US); ANAND S. KONANUR, SUNNYVALE, CA (US); TIMOTHY F. COX, PALO ALTO, CA (US)

(73) Assignee: INTEL CORPORATION, SANTA CLARA, CA (US)

(21) Appl. No.: 15/283,319

(22) Filed: Oct. 1, 2016

(51) Int. Cl. H04W 4/00; H04W 12/02; H04W 52/02

(52) U.S. Cl. CPC H04W 4/008; H04W 52/0258; H04W 12/02

(57) ABSTRACT

Communication devices and techniques for facilitating dual-mode communication within a single wireless communication device are described. In one embodiment, for example, an apparatus may include at least one memory and logic for a wireless communication device, at least a portion of the logic comprised in hardware coupled to the at least one memory, the logic to perform a transmission determination to determine whether to transmit a signal in a low-energy mode or a body-communication mode, map the signal to a body-communication channel responsive to the transmission determination indicating the body-communication mode, and map the signal to a low-energy channel responsive to the transmission determination indicating the low-energy mode. Other embodiments are described and claimed.

### TECHNICAL FIELD

Embodiments herein generally relate to communications in wireless communications networks.

### BACKGROUND

A personal area network (PAN) is a communication system used for data exchange between devices over short distances, typically no more than 10 meters. A PAN may be configured as or may include a body area network (BAN) operating using human body communication (HBC) (also referred to as intra-body communication or body-coupled communication) techniques for communication among devices, sensors, and/or the like in contact with a human body. HBC devices include transceivers capable of sending and receiving signals in close proximity to the body or over the surface of the skin. An HBC device must be in contact with skin directly or be in close proximity to the skin in order to communication with other HBC devices that are in contact with the skin directly or through clothing of the human body associated with the BAN. A PAN may include low energy transmission devices for communication with devices located within short distances. For example Bluetooth® low energy (BLE) may be used for short-range wireless communication.

Power consumption and security is an ever-present problem for wearable, battery operated and rechargeable devices typically used in PANs and BANs. This is particularly true for small body-worn devices, for example, that are expected to operate for long periods of time without re-charging or replacing the battery. Because BLE devices are often designed to operate at a range of 5 to 10 meters, they consume more power than is necessary when the devices are close together, for instance, when they are worn on the body of a user. In addition, device manufacturers are often forced to make tradeoffs between reduced security (for example, allowing a device to pair with any other device upon request) and usability (for example, requiring a user to enter security credentials to permit device pairing).

### BRIEF DESCRIPTION OF THE DRAWINGS

FIG. 1 illustrates an embodiment of a first operating environment.

FIG. 2 illustrates an embodiment of a first logic flow.

FIG. 3 illustrates an embodiment of a second logic flow.

FIG. 4 illustrates an embodiment of a second operating environment.

FIG. 5 illustrates an embodiment of a third operating environment.

FIG. 6 illustrates an embodiment of a storage medium.

FIG. 7 illustrates an embodiment of a device.

### DETAILED DESCRIPTION

Various embodiments may be generally directed to techniques for transmitting information within a personal area network (PAN). In some embodiments, a device may transmit information in one of a plurality of transmission modes based on transmission criteria. In some embodiments, the plurality of transmission modes may a low-energy mode or transmission protocol and a body-communication transmission protocol. In some embodiments, the low-energy mode may include a Bluetooth® low energy (BLE) mode and the body-communication mode may include a human body communication (HBC) mode. In one embodiment, for example, an apparatus may include at least one memory and logic for a wireless communication device, at least a portion of the logic comprised in hardware coupled to the at least one memory, the logic to perform a transmission determination to determine whether to transmit a signal in a low-energy mode or a body-communication mode, map the signal to a body-communication channel responsive to the transmission determination indicating the body-communication mode, and map the signal to a low-energy channel responsive to the transmission determination indicating the low-energy mode.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

The techniques disclosed herein may involve transmission of data over one or more wireless connections using one or more wireless technologies. For example, various embodiments may include wireless communications using Bluetooth® low energy (BLE). Bluetooth is a technology for short distance radio transmission in a band from 2.4 to 2.5 Gigahertz (GHz). Bluetooth low energy (BLE) is a feature of Bluetooth® 4.0 wireless radio technology. While BLE radio circuits are similar to traditional Bluetooth radio circuits, BLE is otherwise significantly different than classic Bluetooth. B LE is aimed at low-power and low-latency, applications for wireless devices within a short range of up to 50 meters. BLE devices consume much less power than prior art Bluetooth circuits, and have the ability to operate for months or even a year on a single battery the size of a nickel or quarter without recharging, thus permitting communication devices such as sensors, including discovery and proximity sensors, and radio transmitters in pacemakers to operate for long periods of time. Bluetooth® is managed by the Bluetooth® Special Interest Group (SIG) and was standardized as Institute of Electrical and Electronics Engineers (IEEE) 802.15.1, although this standard may no longer apply to one or more aspects of either Bluetooth® or BLE. Although BLE technologies are used in example embodiments in this Detailed Description, embodiments are not so limited, as any low-energy or ultra-low frequency wireless technologies capable of operating according to some embodiments are contemplated herein.

Some embodiments may additionally or alternatively involve wireless communications according to other wireless communications technologies and/or standards including, for example, HBC communication techniques. HBC communication has been standardized in IEEE 802.15.6. Accordingly, various embodiments may implement wireless communications according to IEEE 8021.15.6 including any predecessors, revisions, progeny, and/or variants of any of the above. The embodiments are not limited to these examples. Although HBC technologies are used in example embodiments in this Detailed Description, embodiments are not so limited, as any communication technologies using a portion of the human body as a communication channel capable of operating according to some embodiments are contemplated herein.

Examples of other wireless communications technologies and/or standards that may be used in various embodiments may include, without limitation, other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11ah, and/or IEEE 802.11ax standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, and/or 3GPP TS 30.300, and/or near-field communication (NFC) standards such as standards developed by the NFC Forum, including any predecessors, revisions, progeny, and/or variants of any of the above. The embodiments are not limited to these examples.

For example, various embodiments may involve transmissions over one or more wireless connections according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their predecessors, revisions, progeny, and/or variants.

Examples of wireless mobile broadband technologies and/or standards may also include, without limitation, any of the IEEE 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1xRTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

In addition to transmission over one or more wireless connections, the techniques disclosed herein may involve transmission of content over one or more wired connections through one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

HBC has been demonstrated to be very power efficient, for example, as compared to radio frequency (RF)-based technologies. This efficiency makes HBC more feasible to perform high-sampling rate or even continuous monitoring for wearable devices. In addition, HBC signals at 30 MHz are more closely localized around the body compared with, for instance, 2.4 GHz BLE signals. Accordingly, lower frequencies are more efficient and effective for communication on and around the human body.

BLE, also formerly referred to as Bluetooth® Smart, is a short-range wireless communications technology that is commonly used for personal area network and body area network applications. For example, Class 3 BLE devices have a range of about 1 meter; however, most battery operated devices are designed to be class 2 devices with a range of 5-10 meters. Body-worn BLE devices must make a tradeoff between having sufficient range to communicate with a partner device that is not directly on the body (for example, on a table nearby) and the power consumption required to operate over this range and the interference caused to other body-worn BLE systems that are nearby (for example, worn by a person standing a few meters away).

BLE systems operate at frequencies of 2.4 GHz. They divide the frequency band into 40 channels. Three of these channels are used as advertising channels within which BLE devices discover each other and establish a data connection with each other. The other 37 channels are data channels. BLE uses a frequency hopping scheme to mitigate the effects of interference between BLE systems and other RF systems operating in the 2.4 GHz frequency band.

Device and service discovery and determination of user intent are well-known problems for mobile devices within wireless communications systems. In order to find other devices that are in communication range, a device must periodically transmit information about itself so that other devices might hear the device and/or periodically listen for such transmissions from other devices. When a device hears another device, it must further determine whether the other device offers the types of services for which this device is looking. For example, the device may be a printer, or a thermostat, with which a body worn device, such as a smartwatch is not designed to communicate with.

Device and service discovery are a problem for wearable devices because wearable devices consume power while the device is not actually communicating data (for instance, user or sensor data), for example, when the device is listening/talking to other devices regarding device capabilities and services. A tradeoff between power consumption and latency must be made in determining how often a device transmits/listens. The problem of device and service discovery becomes more challenging when the density of BLE devices increases, because the device hears the transmissions of more devices and must consume power processing these transmissions to determine whether the device should initiate communications.

Once a device discovers that another device is in range and offers the right services, the device must determine whether the user intends for the device to communicate with the other device. In BLE, this determination is made as part of the pairing procedure, which is cumbersome and involves manual action from the user, such as the entry of a PIN or device ID number. Devices which do not have output or input capability (for example, a small body-worn sensor) make this problem more difficult. Device manufacturers are forced to make tradeoffs between reduced security and user experience.

Conventional BLE architecture offers an optional out-of-band pairing mechanism which allows a pair of systems with an alternative method of communication to use that method to exchange BLE pairing info. This exchange replaces the manual input of a PIN and provides the determination of user intent. HBC is one of the alternative communication technologies that can be used for this purpose. However, this approach requires the implementation of a complete HBC system (for instance, RF, PHY, MAC, and control and plane signaling) and/or a complete HBC transceiver and protocol stack implementation.

Power consumption of conventional small body-worn devices is controlled mainly by duty cycling communication tasks and circuit design. The potential reductions in power consumption in BLE systems are bounded by the need to operate at high frequencies (for instance, in the GHz range) and the power required to transmit an RF signal through the air. In addition, the human body causes problems for through the air RF transmissions, acting as a potential barrier for the RF signal depending on the location and/or orientation of the transmitter and receiver. Transmission power control might be used to reduce transmitter power consumption, but the variability of the on-body RF channel makes this difficult. HBC consumes substantially less power during active transmission/reception than BLE.

Accordingly, in some embodiments, an apparatus may be configured to communicate using one of a human-contact mode and a low-energy mode based on one or more transmission criteria. In some embodiments, an apparatus may include a BLE module having an HBC transmission mode for communicating via HBC communication techniques. For example, an apparatus according to some embodiments may communicate with devices on a body of a user using HBC electrodes, while transmission to devices that are off of the body (or that are not capable of HBC communication) may be performed using a BLE antenna, for example, through an antenna operating at 2.4 GHz. In various embodiments, the BLE medium access control (MAC) and physical layer (PHY) may be used for all or some apparatus communication.

The problem of device and user discovery is partially addressed in BLE by allowing devices to filter advertisements based on various criteria. This allows the BLE to more efficiently ignore advertisements from certain devices. However, a body worn device using BLE, or another low-energy device, that is to communicate only with other body-worn devices must expend energy receiving advertisements from devices that are not on the body in order to filter them. Accordingly, devices configured according to some embodiments may listens for advertisements using only HBC mode, and may not hear the advertisements of devices that are not on the same body.

In some embodiments, human-contact mode may be applied to certain channels, such as the advertising channels, the data channels, or both. Use of human-contact mode for the advertising channels may operate to, among other things, alleviate challenges with device discovery, service discovery, security, and/or user intent. Use of human-contact mode for the data channels may operate to, among other things, reduce power consumption.

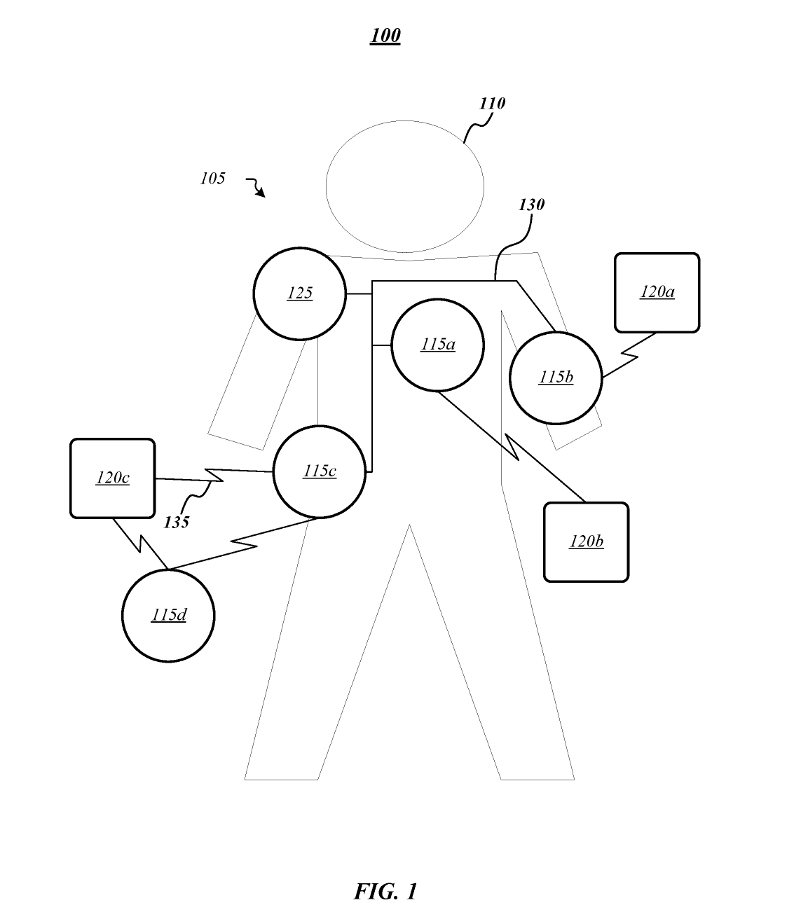

FIG. 1 illustrates an example of an operating environment 100 that may be representative of various embodiments. The operating environment 100 depicted in FIG. 1 may include a personal area network (PAN) associated with a user 110. The PAN may include low-energy human-contact (LEHC) devices 115a-d capable of dual-mode communication. In some embodiments, an LEHC device 115a-d may be capable of communicating in a human-contact mode using human-contact based techniques and a low-energy mode using low-energy based techniques. In some embodiments, the human-contact mode may include HBC techniques. In some embodiments, the low-energy mode may include BLE techniques. In some embodiments, one of the LEHC devices 115a-d may be designated as a master to control communications within the PAN, for example, to ensure that only one type of signal may be transmitted at a time. For example, LEHC device 115b may be a smartwatch that operates as a master of PAN for sensor LEHC devices 115a, 115c, and/or 115d.

LEHC devices 115a-d may be capable of communication with one or more human-contact devices 125 over a human-contact communication path 130. In some embodiments, human-contact device 125 may include a device capable of communicating via HBC and the human-contact communication path 130 may include transmission of HBC signals. In some embodiments, HBC signals may include signals according to IEEE 802.15.6 standard. In some embodiments, HBC signals may include 30 MHz signals. LEHC devices 115a-d may be capable of communication with one or more low-energy devices 120a-c over a low-energy communication path 135. In some embodiments, low-energy devices 120a-c may include devices capable of communicating via BLE and the low-energy communication path 135 may include transmission of BLE signals. In some embodiments, BLE signals may include 2.4 GHz signals transmitted/received using a BLE antenna, transceiver, and/or the like. In some embodiments, LEHC devices 115a-d may include a BLE-HBC device operative to communicate in one of a BLE mode and an HBC mode.

LEHC devices 115a-d may be capable of communication with other LEHC devices 115a-d over one of human-contact communication path 130 and/or low-energy communication path 135. For example, LEHC device 115c may communicate with LEHC device 115d, which is not in contact with the body of user 110, via low-energy communication path 135. In another example, LEHC device 115c may communicate with LEHC device 115a, both of which are in contact with the body of user 110, via human-contact communication path 130.

LEHC devices 115a-d, human-contact device 125, and low-energy devices 120a-c may include various devices, sensors, circuits, computing devices, and/or the like. In some embodiments, LEHC devices 115a-d, human-contact device 125, and low-energy devices 120a-c may include various wearable devices and/or sensors and articles including devices and/or sensors, such as watches, jewelry, clothing, glasses, headphones, personal monitoring sensors, health monitoring sensors, accelerometer, impact sensors, geolocation sensor, heart monitors, pulse monitors, glucose monitors, blood oxygen sensors, brain wave sensors, environmental sensors, smart home sensors and/or devices, smart grid sensors and/or devices, Internet of Things (TOT) sensors and/or devices, and/or the like. In some embodiments, LEHC devices 115a-d, human-contact device 125, and low-energy devices 120a-c, may include a device capable of human-contact communication when communicatively coupled to the skin of user 110 (or in close proximity to the skin to facilitate communication), for example by direct contact with the skin of the user or through clothing of user (or in close proximity to the skin to facilitate communication). In some embodiments, LEHC devices 115a-d, human-contact device 125, and low-energy devices 120a-c may include non-wearable devices such computing device, a laptop, a smartphone, a tablet computing device, a camera, a smart watch, a personal digital assistants (PDA), and/or the like that may be communicatively coupled to the skin of the user (or in close proximity to the skin to facilitate communication) when in contact with the user (for example, when the user holds the device or touches a touch screen input element of the device).

In some embodiments, human-contact mode may be implemented in an LEHC device 115a-d, for example, in a BLE-HBC device capable of communicating using one of BLE signals and HBC signal. For example, a BLE-HBC device may operate by converting a modulated signal between the frequency of the BLE physical channel to which the signal is assigned and the HBC channel on which the signal is to be transmitted.

Included herein is a set of logic flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on a non-transitory computer readable medium or machine readable medium, such as an optical, magnetic or semiconductor storage. The embodiments are not limited in this context.

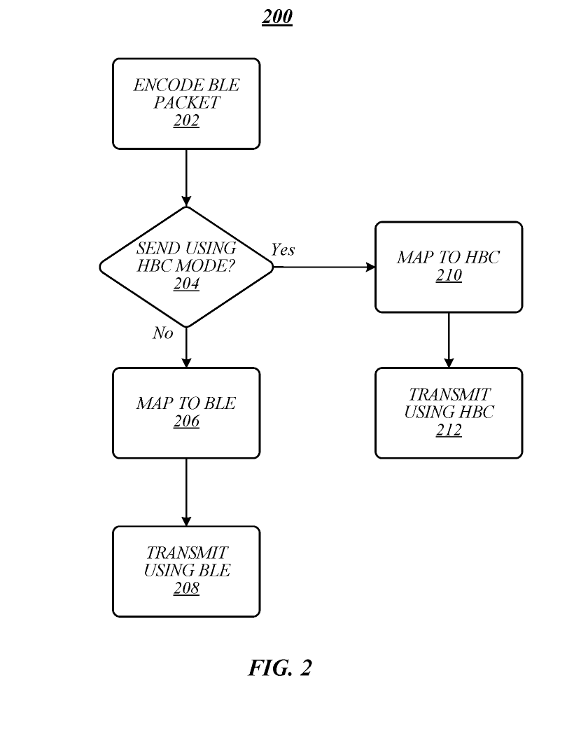

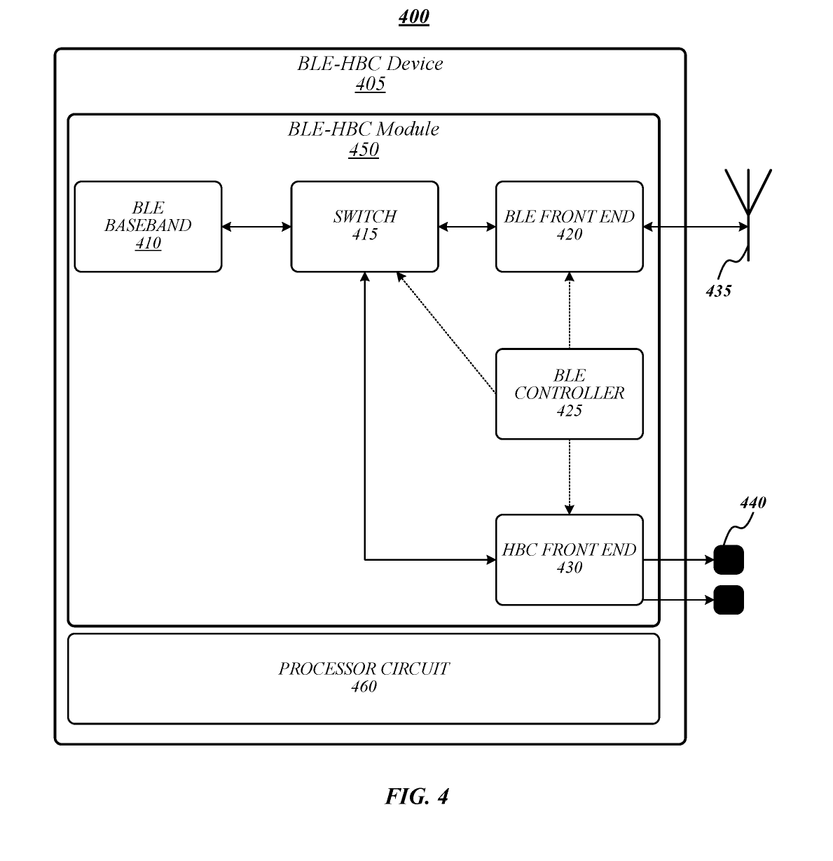

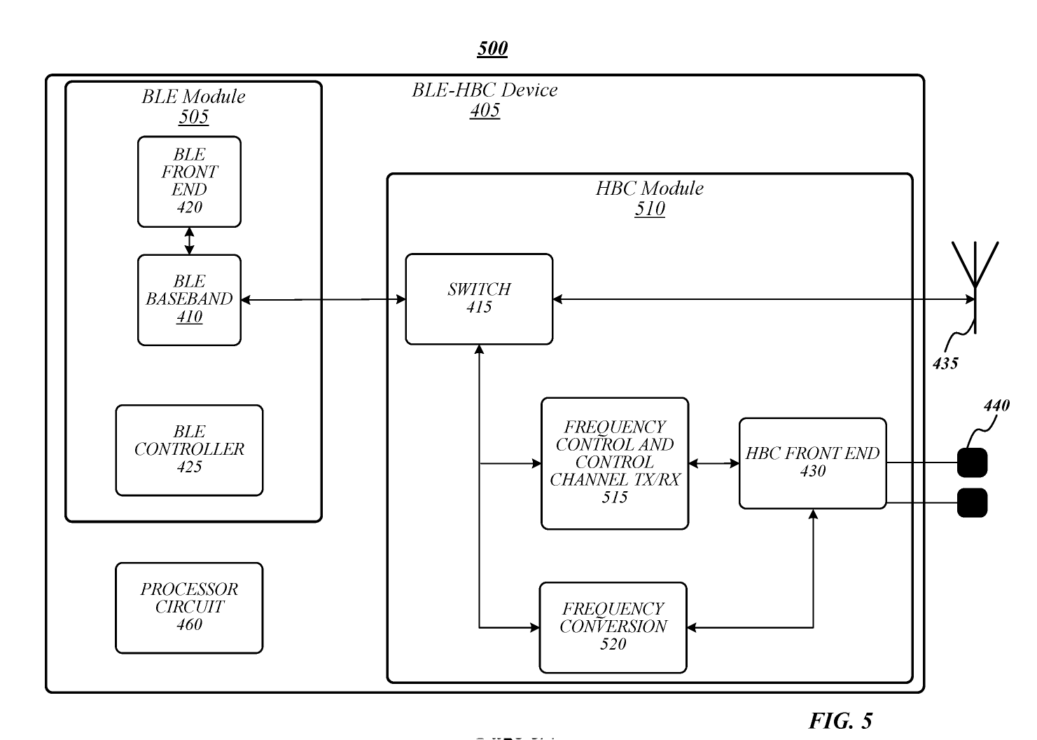

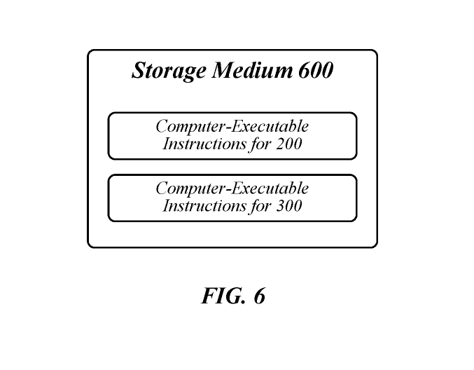

FIG. 2 illustrates an embodiment of a logic flow 200. The logic flow 200 may be representative of some or all of the operations executed by one or more embodiments described herein, such as one of LEHC devices 115a-d, BLE-HBC device 405 (see FIGS. 4 and 5), and/or apparatus 600 (see FIG. 6). Logic flow 200 may be representative of some or all of the operations for transmitting a signal via BLE or HBC via a device or apparatus configured according to some embodiments.

In the illustrated embodiment shown in FIG. 2, the logic flow 200 at block 202 may encode a BLE packet. For example, a BLE packet may be encoded and modulated according to a BLE specification. At block 204, the logic flow 200 may perform a transmission determination to determine which mode to transmit the BLE packet, such as whether to transmit the BLE packet in an HBC mode. The transmission determination may be based on various transmission factors. For example, a body-communication transmission factor may indicate whether a communication is destined for a device in contact with the human body of a user and capable of human-contact communication. If the human-contact transmission factor is true or otherwise indicates that the destination device is capable of human-contact communication, then the transmission determination may be set to transmit the packet, information, signal, or the like via human-contact communication techniques (for example, using HBC). If the human-contact transmission factor is false or otherwise indicates that the destination device is not capable of human-contact communication, then the transmission determination may be set to transmit the packet, information, signal, or the like via low-energy communication techniques (for example, using BLE). The transmission factors may include a historical transmission factor configured to indicate past communications with a destination device. For example, the transmission determination may determine a communication mode based on previous communications with the destination device. Embodiments are not limited in this context. In some embodiments, the transmission factors may include a transmission mode factor indicating, for instance, that the transmitting device may operate using one or more communication protocols. For instance, the transmission mode factor may indicate that a transmitting device may only transmit in a body-communication mode (for instance, using an HBC communication protocol), in a low-energy mode (for instance, using a BLE communication protocol), or using both a body-communication mode and a low-energy mode.

If the BLE packet is to be transmitted in BLE mode, the logic flow 200 at block 206 may map the signal to a BLE channel (for example, one of the data or advertising channels) and the signal may transmitted via the mapped BLE channel by logic flow 200 at block 208. If the BLE packet is to be transmitted in HBC mode, the logic flow 200 at block 210 may map the signal to an HBC channel and the signal may transmitted via the mapped HBC channel by logic flow 200 at block 212.

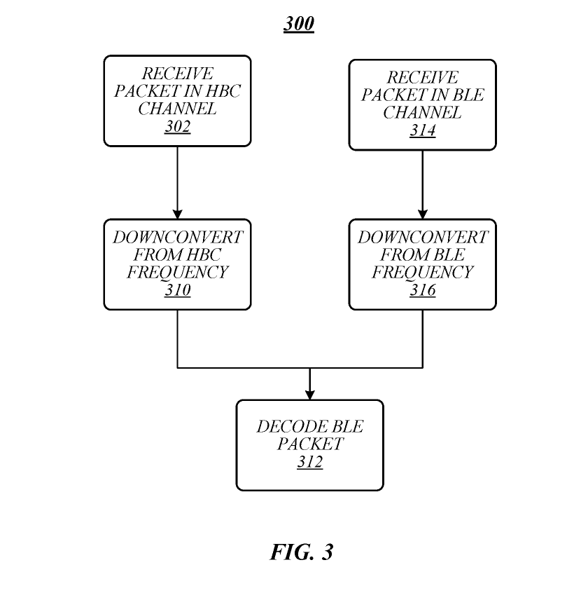

FIG. 3 illustrates an embodiment of a logic flow 300. The logic flow 300 may be representative of some or all of the operations executed by one or more embodiments described herein, such as one of LEHC devices 115a-d, BLE-HBC device 405, and/or apparatus 600. Logic flow 300 may be representative of some or all of the operations for receiving a signal via BLE or HBC at a device or apparatus configured according to some embodiments.

In the illustrated embodiment shown in FIG. 3, the logic flow 300 at block 302 may receive a packet in an HBC physical channel. At block 304, the logic flow 300 may down-convert the packet from the HBC frequency and decode the down-converted packet at block 306. The logic flow 300 at block 308 may receive a packet in a BLE physical channel. At block 310, the logic flow 300 may down-convert the packet from the BLE frequency and decode the down-converted packet at block 312.

FIG. 4 illustrates an example of an operating environment 400 that may be representative of various embodiments. The operating environment 400 depicted in FIG. 4 may include a BLE-HBC device 405 for transmitting and receiving communication signals according to BLE and HBC techniques. As shown in FIG. 4, BLE-HBC device 405 may include a processor circuit 460. Processor circuit 460 may be generally arranged to execute one or more operations to perform various functions according to some embodiments. Processor circuit 460 can be any of various commercially available processors, for example, configured for BLE and/or HBC devices, including, without limitation, Intel® Quark™ family of processors, AMD® Cortex® family of processors, a system on a chip (SoC), and/or the like.

In some embodiments, BLE-HBC device 405 may be formed in an integrated configuration in which a BLE module is coupled to HBC transmission capabilities directly into a BLE module, for example, in the form of an integrated BLE-HBC module 450. When transmitting data, the BLE controller 425 may make a transmission determination for whether a transmission should be performed using BLE physical channels or HBC physical channels. For example, if the transmission determination indicates that a transmission should be transmitted using BLE physical channels, a switch 415 may be set to direct the flow of data, information, packets, frames, or other signals through a BLE front end 420 for transmission via antenna 435. In another example, if the transmission determination indicates that a transmission should be transmitted using HBC physical channels, switch 415 may be set to direct the flow of data, information, packets, frames, or other signals through an HBC front end 430 for transmission via electrodes 440. The packets may be generated by the BLE baseband 410 for both HBC transmission via HBC front end 430 and BLE transmission via BLE front end. When a signal is received by BLE-HBC module, the BLE controller 425 may direct the BLE front end 420 or the HBC front end 430 to receive the signal and pass the baseband signal to the BLE baseband 410.

The frequency conversion to a BLE frequency or an HBC frequency may be performed from a baseband signal or from an intermediate frequency signal. The determination of which particular BLE physical channel or HBC physical channel may be performed by a controller at the transmitter and receiver of the corresponding front end, such as BLE front end 420 and HBC front end 430, respectively, according to a set of pre-determined policies. For instance, a determination of the BLE physical channel may be determined according to policies of a corresponding BLE specification. The determination of which HBC channel may be determined based on various mapping processes.

FIG. 5 illustrates an example of an operating environment 500 that may be representative of various embodiments. As shown in FIG. 5, a BLE-HBC device may include a BLE module 505 and an HBC module 510. The RF output of BLE module 505 from the BLE baseband 410 may be passed through switch 415, which either sends the RF signal to the BLE antenna 435 for transmission through the air, or converts the signal to an HBC signal for HBC transmission via electrodes 440.

When transmitting a signal, the HBC module 510 may determine which physical channel the BLE module 505 is using for the transmission. In some embodiments, a frequency control and control channel TX/RX element 515 (a “frequency and control” element) may determine which physical channel the BLE module 505 is using for the transmission and provide the center frequency to a frequency conversion element 520. The frequency conversion element 520 may perform frequency conversion from the BLE physical channel (for example, in the 2.4 GHz band) to a channel in the HBC band (for example, about 30 MHz).

In some embodiments, more than one physical channel may be used for HBC transmission. The frequency and channel control element 515 may determine both the BLE physical channel and the HBC physical channel. The identity of the BLE physical channel may be sent over HBC in order for a receiving device to perform conversion of the signal for input to a BLE configuration, such as a BLE module 505. In some embodiments, BLE physical channel identification information may be transmitted along with the BLE data, for example, immediately prior to the BLE data. In various embodiments, the frequency and channel control element 515 may include an implementation of HBC PHY and/or MAC layers to operate according to some embodiments. When receiving a signal, HBC module 510 may decode the identity of the BLE physical channel based on information transmitted in or with the data. Frequency conversion element 520 may convert the signal to the expected BLE physical channel and the signal may be sent to BLE module 505, for instance, via switch 415.

In various embodiments, BLE-HBC device 405 may be formed in an independent or decoupled in which BLE-HBC device 405 includes an individual BLE module 505 and an individual HBC module 510. The HBC module 510 depicted in FIG. 5 may be communicatively coupled with existing BLE systems. For example, the BLE baseband 410 output may be coupled with switch 415 of independently operational HBC module 510. Switch 415 may manage transmission of BLE signals from BLE-HBC device 405 via BLE antenna 435 if the transmission determination is set to BLE, and via electrodes 440 if the transmission determination is set to HBC.

In some embodiments, the BLE module 505 may have a maximum delay, for example, specified according to BLE specifications, for transmitting a packet on a channel. In some embodiments the maximum delay may be about 16 μs. Accordingly, in some embodiments, the HBC module 510 may operate to transmit a packet initiated by the BLE module 505 prior to expiration of the maximum delay.

References to BLE-HBC device 405 may refer to a BLE-HBC device in an integrated configuration (for example, in FIG. 4) or in a coupled configuration (for example, in FIG. 5), unless otherwise specified. In some embodiments, transmission of signals by BLE-HBC device 405 on the advertisement channels may be performed over HBC in order to limit communications to devices that are communicatively coupled to the body of the same user as BLE-HBC device 405 or to identify devices that are also communicatively coupled to the body of the same user. In some embodiments, the three BLE advertisement channels may be mapped to one HBC physical channel. In some embodiments, the three BLE advertisement channels may be mapped to three HBC physical channels. In various embodiments, BLE-HBC device 405 may be configured to transmit advertisement signals only using HBC physical channels. In some embodiments, BLE-HBC device 405 may be configured to transmit advertisement signals using HBC physical channels and BLE physical channels.

In some embodiments, BLE-HBC device 405 may implement a body-communication communication mode in which BLE-HBC device 405 only communicates with devices that are on the body of the user. In the body-communication communication mode, BLE-HBC device 405 transmits advertisement signals only over HBC physical channels and BLE-HBC device 405 may only pair with devices that are directly communicatively coupled with the body of the same user as BLE-HBC device 405. Accordingly, user intent may be determined by assuming, for instance, that devices on the body of the same user are intended to communicate. For example, a BLE-HBC device 405 may include a sensor node configured to send data to an aggregation device, such as a watch when worn on the body of the user. In some embodiment, BLE-HBC device 405 transmission only via HBC mode may be supported by mapping all transmissions (for instance, advertisement channels and data channels) to HBC and not transmitting over BLE channels via BLE antenna 435.

In embodiments in which BLE-HBC device 405 transmits advertisement signals using HBC physical channels and BLE physical channels, BLE-HBC device 405 may be discovered by devices that are on the body of the same use or are within RF range. In various embodiments, if a response to an advertisement in such embodiments is received via HBC, BLE-HBC device 405 may assume that the device is on the body of the same user as BLE-HBC device 405 and the devices may negotiate to perform data communications using HBC as the transmission mechanism.

In some embodiments, BLE-HBC device 405 may be configured to only listen for HBC signals, such as advertisement signals, for example, to only communicate with devices that are on the body of the same user. In some embodiments, BLE-HBC device 405 may be configured to listen for BLE signals and HBC signals, such as advertisement signals, to determine which devices are on the body of a user and which are off the body of the user.

In some embodiments, BLE-HBC device 405 may transmit data channel traffic over HBC in order to take advantage of the power savings and/or reduction in interference to other systems in RF range (for instance, within range of PAN 105). For data channels, transmission on all of the 37 BLE physical channels may be mapped to one HBC channel. For example, frequency hopping may not be required because of the low risk for interference. In another example, the network, such as PAN 105, may be configured to include one device operating as a master on the body so that there will be only one transmission at a time. In some embodiments, BLE-HBC devices 405 communicating using the HBC mode must first determine that they are both on the body of the user by sending/receiving the advertisement connection set up messages using HBC mode, for example, via BLE-HBC module 450 or HBC module 510.

In some embodiments, BLE-HBC device 405 may implement a BLE contact-only mode in which BLE-HBC device 405 only pairs with devices that are communicatively coupled to the body of the user, but communicates with the devices via BLE RF transmissions. The BLE contact-only usage configuration may be supported by mapping all advertisement channel transmissions to HBC and not transmitting them on the BLE channels, while not mapping any data channel transmissions to HBC and transmitting data channel transmissions only using BLE.

In some embodiments, BLE-HBC device 405 may implement a hybrid mode in which BLE-HBC device transmits data using HBC to devices that are on the body of the user, while also sending/receiving data using BLE RF transmissions, for instance, to devices that are not on the body of the user. BLE-HBC device 405 may support hybrid mode by transmitting advertising messages using both HBC and BLE RF transmissions. When a device responds to an advertisement, BLE-HBC device 405 may determine if the other device is on the body of the user by exchanging advertisements over HBC channels. If the other device is on the body of the user, BLE-HBC device 405 and the other device may communicate via HBC. If the other device is not on the body of the user, BLE-HBC device 405 may communicate with the over device via BLE.

FIG. 6 illustrates an embodiment of a storage medium 600. Storage medium 600 may comprise any non-transitory computer-readable storage medium or machine-readable storage medium according to some embodiments. In some embodiments, storage medium 600 may store computer-executable instructions, such as computer-executable instructions to implement logic flow 200 of FIG. 2 and/or logic flow 300 of FIG. 3.

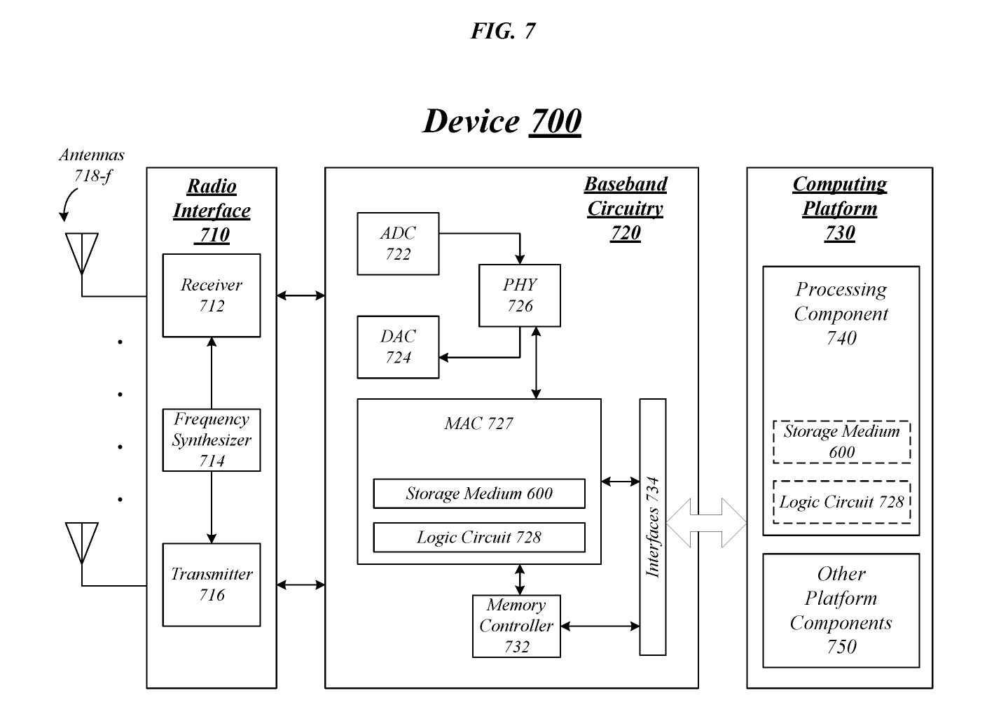

FIG. 7 illustrates an embodiment of a communications device 700 that may implement one or more of LEHC device 75a-d, BLE-HBC device 405, logic flow 200 of FIG. 2, or logic flow 300 of FIG. 3. In various embodiments, device 700 may comprise a logic circuit 728. The logic circuit 728 may include physical circuits to perform operations described for one or more of LEHC device 75a-d, BLE-HBC device 405, logic flow 200 of FIG. 2, or logic flow 300 of FIG. 3, for example. As shown in FIG. 7, device 700 may include a radio interface 710, baseband circuitry 720, and computing platform 730, although the embodiments are not limited to this configuration.

The device 700 may implement some or all of the structure and/or operations for one or more of LEHC device 75a-d, BLE-HBC device 405, logic flow 200 of FIG. 2, or logic flow 300 of FIG. 3, and logic circuit 728 in a single computing entity, such as entirely within a single device. Alternatively, the device 700 may distribute portions of the structure and/or operations for one or more of LEHC device 75a-d, BLE-HBC device 405, logic flow 200 of FIG. 2, or logic flow 300 of FIG. 3, and logic circuit 728 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 710 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 710 may include, for example, a receiver 714, a frequency synthesizer 714, and/or a transmitter 716. Radio interface 710 may include bias controls, a crystal oscillator and/or one or more antennas 718-f. In another embodiment, radio interface 710 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 720 may communicate with radio interface 710 to process receive and/or transmit signals and may include, for example, a mixer for down-converting received RF signals, an analog-to-digital converter 722 for converting analog signals to digital form, a digital-to-analog converter 724 for converting digital signals to analog form, and a mixer for up-converting signals for transmission. Further, baseband circuitry 720 may include a baseband or physical layer (PHY) processing circuit 726 for PHY link layer processing of respective receive/transmit signals. Baseband circuitry 720 may include, for example, a medium access control (MAC) processing circuit 727 for MAC/data link layer processing. Baseband circuitry 720 may include a memory controller 732 for communicating with MAC processing circuit 727 and/or a computing platform 730, for example, via one or more interfaces 734.

In some embodiments, PHY processing circuit 726 may include a frame construction and/or detection module, in combination with additional circuitry such as a buffer memory, to construct and/or deconstruct communication frames. Alternatively or in addition, MAC processing circuit 727 may share processing for certain of these functions or perform these processes independent of PHY processing circuit 726. In some embodiments, MAC and PHY processing may be integrated into a single circuit.

The computing platform 730 may provide computing functionality for the device 700. As shown, the computing platform 730 may include a processing component 740. In addition to, or alternatively of, the baseband circuitry 720, the device 700 may execute processing operations or logic for one or more of LEHC device 75a-d, BLE-HBC device 405, logic flow 200 of FIG. 2, or logic flow 300 of FIG. 3, and logic circuit 728 using the processing component 740. The processing component 740 (and/or PHY 726 and/or MAC 727) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 730 may further include other platform components 750. Other platform components 750 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g.,

USB memory, solid state drives (SSD) and any other type of storage media suitable for storing information.

Device 700 may be, for example, a sensor, an IOT device, a BLE device, an HBC device, a BLE-HBC device, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 700 described herein, may be included or omitted in various embodiments of device 700, as suitably desired.

Embodiments of device 700 may be implemented using single input single output (SISO) architectures. However, certain implementations may include multiple antennas (e.g., antennas 718-f) for transmission and/or reception using adaptive antenna techniques for beamforming or spatial division multiple access (SDMA) and/or using MIMO communication techniques.

The components and features of device 700 may be implemented using any combination of discrete circuitry, application specific integrated circuits (ASICs), logic gates and/or single chip architectures. Further, the features of device 700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 700 shown in the block diagram of FIG. 7 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
at least one memory; and
logic for a wireless communication device, at least a portion of the logic comprised in hardware coupled to the at least one memory, the logic to:
perform a transmission determination to determine whether to transmit a signal in a low-energy mode or a body-communication mode;
map the signal to a body-communication channel responsive to the transmission determination indicating the body-communication mode; and
map the signal to a low-energy channel responsive to the transmission determination indicating the low-energy mode.

2. The apparatus of claim 1, the low-energy mode comprising a Bluetooth low energy (BLE) communication protocol.

3. The apparatus of claim 1, the body-communication mode comprising a human body communication (HBC) communication protocol.

4. The apparatus of claim 1, the logic to transmit the signal via at least one low-energy antenna responsive to the transmission determination indicating the low-energy mode.

5. The apparatus of claim 1, the logic to transmit the signal via at least one electrode coupled to a body of a user responsive to the transmission determination indicating the low-energy mode

6. The apparatus of claim 1, the logic to encode the signal using a low-energy communication protocol.

7. The apparatus of claim 1, the logic to convert the signal for transmission over the low-energy channel responsive to the transmission determination indicating the low-energy mode.

8. The apparatus of claim 1, the logic to indicate the transmission determination of the body-communication mode based on a body-communication transmission factor.

9. The apparatus of claim 1, comprising:
a Bluetooth low energy (BLE) module for communication in the low-energy mode, and
a human body communication (HBC) module for communication in the body-communication mode, the HBC module comprising:
at least one electrode for transmitting HBC signals, and
a switch configured to receive a BLE signal from the BLE module for transmission as the HBC signal.

10. The apparatus of claim 1, comprising a Bluetooth low energy (BLE)-human body communication (HBC) module for communication in one of the low-energy mode and the body-communication mode.

11. A computer-readable storage medium that stores instructions for execution by processing circuitry of a wireless communication device, the instructions to cause the wireless communication device to:
perform a transmission determination to determine whether to transmit a signal in a low-energy mode or a body-communication mode;
map the signal to a body-communication channel responsive to the transmission determination indicating the body-communication mode; and
map the signal to a low-energy channel responsive to the transmission determination indicating the low-energy mode.

12. The computer-readable storage medium of claim 11, the low-energy mode comprising a Bluetooth low energy (BLE) communication protocol.

13. The computer-readable storage medium of claim 11, the body-communication mode comprising a human body communication (HBC) communication protocol.

14. The computer-readable storage medium of claim 11, the instructions to cause the wireless communication device to transmit the signal via at least one low-energy antenna responsive to the transmission determination indicating the low-energy mode.

15. The computer-readable storage medium of claim 11, the instructions to cause the wireless communication device to transmit the signal via at least one electrode coupled to a body of a user responsive to the transmission determination indicating the low-energy mode.

16. The computer-readable storage medium of claim 11, the instructions to cause the wireless communication device to encode the signal using a low-energy communication protocol.

17. The computer-readable storage medium of claim 11, the instructions to cause the wireless communication device to convert the signal for transmission over the low-energy channel responsive to the transmission determination indicating the low-energy mode.

18. The computer-readable storage medium of claim 11, the instructions to cause the wireless communication device to indicate the transmission determination of the body-communication mode based on a body-communication transmission factor.

19. An apparatus, comprising:
at least one memory; and
logic for a wireless communication device, at least a portion of the logic comprised in hardware coupled to the at least one memory, the logic to:
determine a low-energy physical channel from information of a body-communication signal,
convert the body-communication signal to a low-energy signal on the low-energy signal physical channel, and
decode the low-energy signal.

20. The apparatus of claim 20, the low-energy signal comprising a signal corresponding to a Bluetooth low energy (BLE) communication protocol.

21. The apparatus of claim 20, the body-communication mode signal comprising a signal corresponding to a human body communication (HBC) communication protocol.

22. The apparatus of claim 20, comprising at least one electrode to receive the body-communication signal.

23. The apparatus of claim 20, the body-communication signal transmitted via a body-communication path comprising a skin of a user.

24. The apparatus of claim 20, the body-communication signal comprising an advertisement signal from a body-communication device.
